(19) United States
(12) Patent Application Publication
(10) Pub. No.: US 2016/0182698 A1
(43) Pub. Date: Jun. 23, 2016

(54) Hands-Free Electronic Device Holder

(71) Applicant: Paul Gordon, Chatsworth, CA (US)

(72) Inventor: Paul Gordon, Chatsworth, CA (US)

(21) Appl. No.: 14/577,883

(22) Filed: Dec. 19, 2014

(51) Int. Cl. H04M 1/04; H04M 1/12

(52) U.S. Cl. CPC H04M 1/04; H04M 1/12

(57) ABSTRACT

A hands-free electronic device holder comprises a belt having a mold at a center position, the mold having a threaded stud therein, a flexible gooseneck having a proximal end and a distal end, the proximal end having a ball insert for attachment with the belt and the distal end having a rotatable attachment means, and a holding assembly having a pair or padded clamps for adjustably holding an electronic device. The holding assembly is attached to the distal end of the flexible gooseneck. The belt is wrapped around a waist of a user. The flexible gooseneck is configured to be adjusted to any orientation to align the position of the electronic device to be at thee level of the user, providing hands-free operation of the electronic device while sitting down, standing, moving, and reclining.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

This embodiment relates to electronic device holders, and more particularly to a hands-free holder for electronic devices such as smart phones, tablets, video MP3 players, mobile telephones and personal digital assistants (PDAs), which allows a user to hold the device in front of the face while sitting down, standing, moving, reclining.

### DISCUSSION OF RELATED ART

Electronic devices have become popular, providing on-the-go entertainment and data access. Because of their decreased size and weight, portable electronic devices are easily transportable and thus they may be carried by people when performing physical activities such as walking, running, cycling, stair climbing, etc. In some cases, the devices are held in the user's hand, while in other cases the devices are carried in a pocket or worn by the user attaching them to a belt or by strapping them to the arm thus freeing their hands. Some electronic devices such as smart phones, video players, and tablet computers may require a user to use both hands, particularly when trying to enter data on the on-screen keyboard.

When the device is held for long periods of time, the arm muscle fatigue can result, and the height of the device is lowered from a comfortable eye-level to the level of the user's table or lap. This can cause excessive flexion of the cervical and thoracic vertebral bodies, resulting in joint pain, inflammation, and stiffness of the back and neck, as well as potential injury to the neck muscles and spinal column. Use of the device without having to hold it with the hands would be ideal for prolonged use. Portable electronic devices, however, do not lend themselves to hands-free use because of the small screen and shape that limits the ability to comfortably tilt or raise the screen to a comfortable position for an extended period of time.

In some existing electronic device holders, an electronic device storage chamber has a shoulder strap attached to a top end of the storage chamber, a chest strap attached to a surface of the storage chamber, a bottom arm attached to a bottom end of the storage chamber, a joint attached to the bottom arm, and an electronic device support arm having a first end attached to the ball joint. In one embodiment, a phone arm can be attached to a surface of the electronic device storage chamber to adjustably support the position of a phone so that a user can simultaneously use the phone and the electronic device, such as a tablet, in a hands-free manner. However, the device holder is complicated in structure, difficult to wear, and offers little comfort to the user.

Some other existing hands-free electronic device holders provide the capability for holding handheld electronic devices at or below the user's eye level at a typical distance of 20 to 30 cm. This hands-free device holder has a flexible adjustable gooseneck, the proximal end of which carries a tab having two spring pins that securely engage with a pocket member. A secure attachment means keeps the pocket member attached to the backside of the handheld electronic device, and two lateral slots receive the pins. The distal end of the flexible, adjustable gooseneck connects to a spring clip similar to a clothes line pin, which attaches the hands-lice electronic device holder to an airline dining tray or a worktable. However, this electronic device holder cannot be worn on the body of a user.

Another existing electronic device holder provides a collapsible hands-free electronic device holder worn upon the chest of a user and supported by a shoulder harness. The electronic device is securely attached and held by the holder at a comfortable viewing height and angle for the user. Some other existing electronic device holders provide a hands-free carrier that has a headset, an extension boom, and a holder assembly for the electronic device. The headset is attached to one end of the extension boom and the holder assembly is attached to the other end of the extension boom via a connection assembly. The hands-free carrier supports the electronic media player at an easy-to-read angle. However, such electronic device holders hinder the free movement of the user wearing them.

Therefore, there is a need for a hands-free electronic device holder that would maintain the electronic device at the face level of the user. Such a needed holder would be able to rotate the electronic device 360 degrees and position the device at the right distance and angle for convenient viewing while moving, sitting, standing, or reclining position. Further, this holder would be easy to attach and adjustable. It would be stable, light-weight, have rigid but adjustable positioning elements and portable. Finally, the holder would be superior in comfort and convenience, without sacrificing portability, stability, versatility, and/or aesthetics. The present embodiment accomplishes these objectives.

### SUMMARY OF THE DISCLOSURE

The present embodiment is a hands-free electronic device holder that supports an electronic device at the face level of a user for hands-free operation. The hands-free electronic device holder comprises in general a belt, a flexible gooseneck and a holding assembly. The belt has a mold at a centre position with a threaded stud in the middle for attachment of the flexible gooseneck to the belt. The belt secures the hands-free electronic device holder to the waist the user and provides support to the flexible gooseneck.

The flexible gooseneck has a proximal end having a ball insert and a threaded cap over the ball insert for attachment with the belt and a distal end having a rotatable attachment means for attachment with the holding assembly. The flexible gooseneck may be adjusted to any orientation to suit a user. The holding assembly has pair of padded clamps for adjustably holding the electronic device in place. The pair of padded clamps open and close to fit different sizes of electronic devices. The holding assembly also has a fixed attachment means at a back portion for attachment with the distal end of the flexible gooseneck. The rotatable attachment means may be rotated in 360 degrees to change the orientation of a screen of the electronic device held in the holding assembly.

The hands-free electronic device holder is capable of positioning the device at the right distance and angle for convenient viewing and hands-free operation while moving, sitting, standing, or reclining position.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a perspective view of a hands-free electronic device holder in accordance with a preferred embodiment of the present invention;

FIG. 2 illustrates the hands-free electronic device holder holding an electronic device in accordance with a preferred embodiment of the present invention;

FIG. 3 is an enlarged front perspective view of a belt of the hands-free electronic device holder in accordance with the preferred embodiment of the present invention;

FIG. 3A is a front view of the belt of the hands-free electronic device holder in accordance with the preferred embodiment of the present invention;

FIG. 3B illustrates a perspective view of the belt connected to a flexible gooseneck in accordance with the preferred embodiment of the present invention;

FIG. 4 is a perspective view of the flexible gooseneck off the hands-free electronic device holder in accordance with the preferred embodiment of the present invention;

FIG. 5 illustrates an enlarged perspective view of the belt and the flexible gooseneck connected together in accordance with the preferred embodiment of the present invention;

FIG. 6 illustrates an enlarged perspective view of a rotating attachment means of the flexible gooseneck in accordance with the preferred embodiment of the present invention;

FIG. 7 is a rear view of the holding assembly of the hands-free electronic device holder in accordance with the preferred embodiment of the present invention; and

FIGS. 8-9 illustrate the hands-free electronic device holder worn by a user.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. The following detailed descriptions should not be taken in a limiting sense.

In this document, the terms “a” or “an” are used, as is common in patent documents, to include one or more than one. in this document, the term “or” is used to refer to a nonexclusive “or ” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

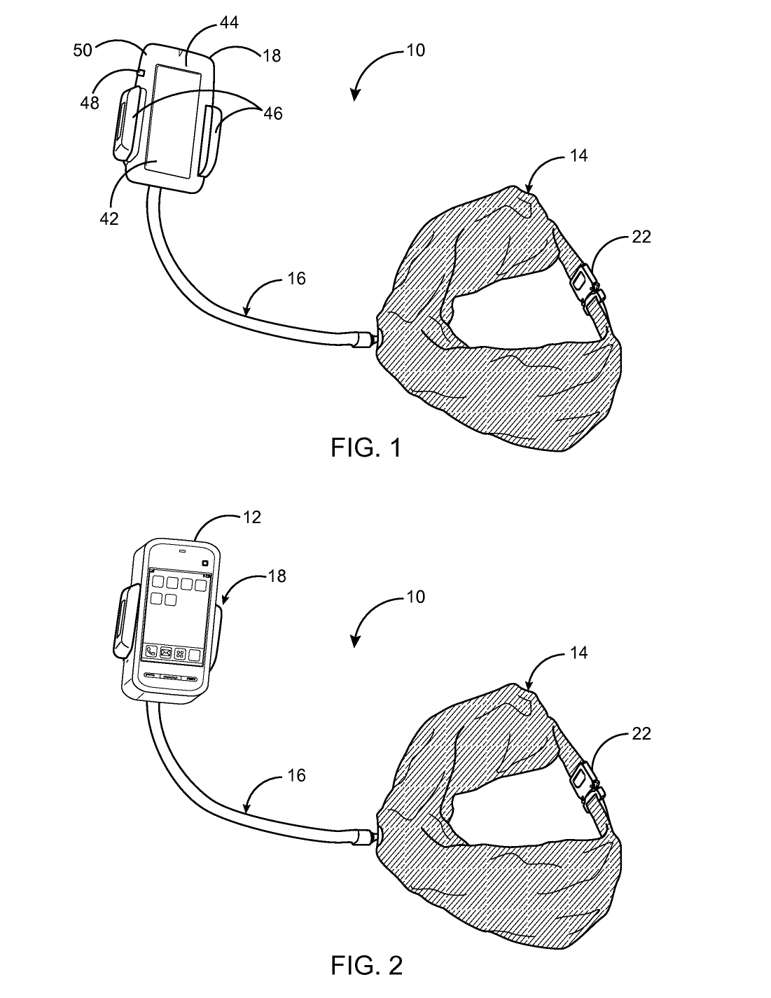

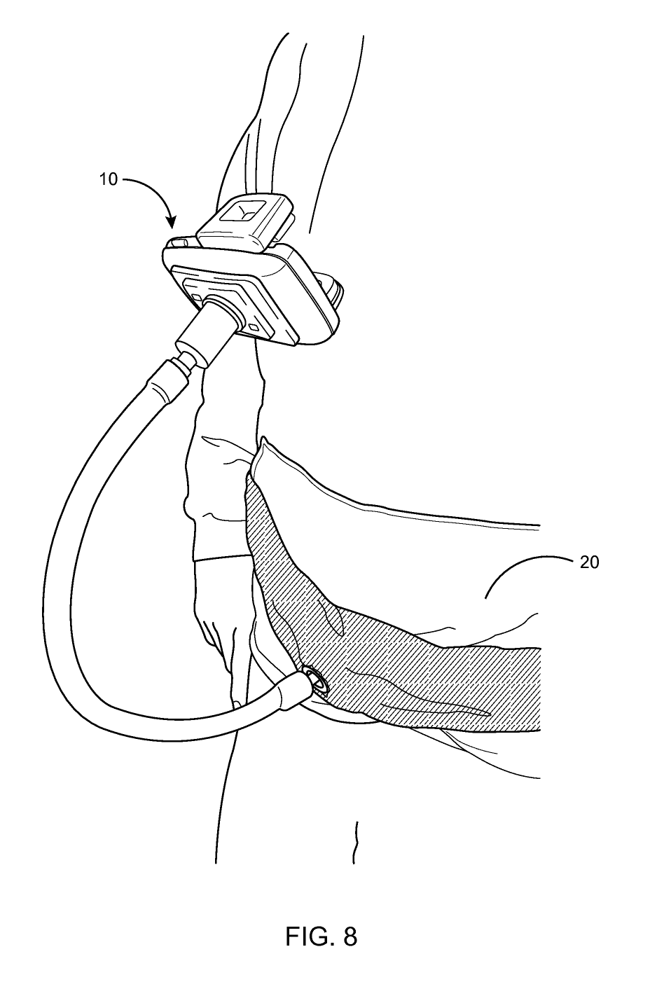

FIG. 1 is a perspective view of a hands-free electronic device holder 10 in accordance with a preferred embodiment of the present invention. FIG. 2 illustrates the hands-free electronic device holder 10 shown holding an electronic device 12 in accordance with the preferred embodiment of the present invention. Referring to FIGS. 1 and 2, the hands-free electronic device holder 10 comprises in general a belt 14, a flexible gooseneck 16 and a holding assembly 18. The belt 14 is wrapped around the waist of a user 20 (See FIG. 8) via a fastening means 22.

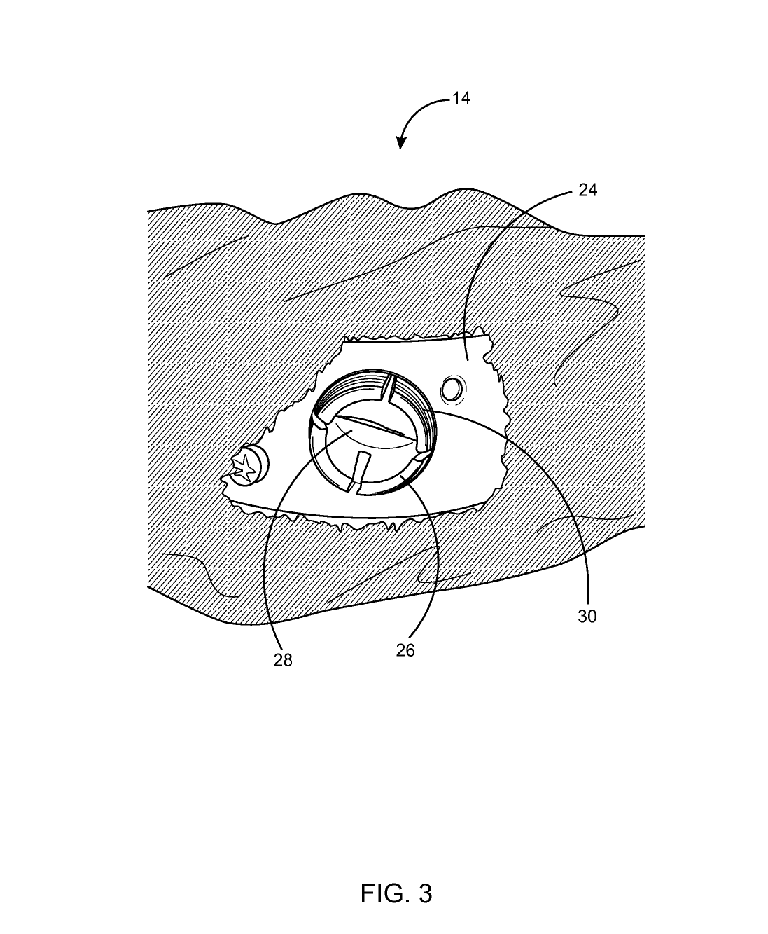

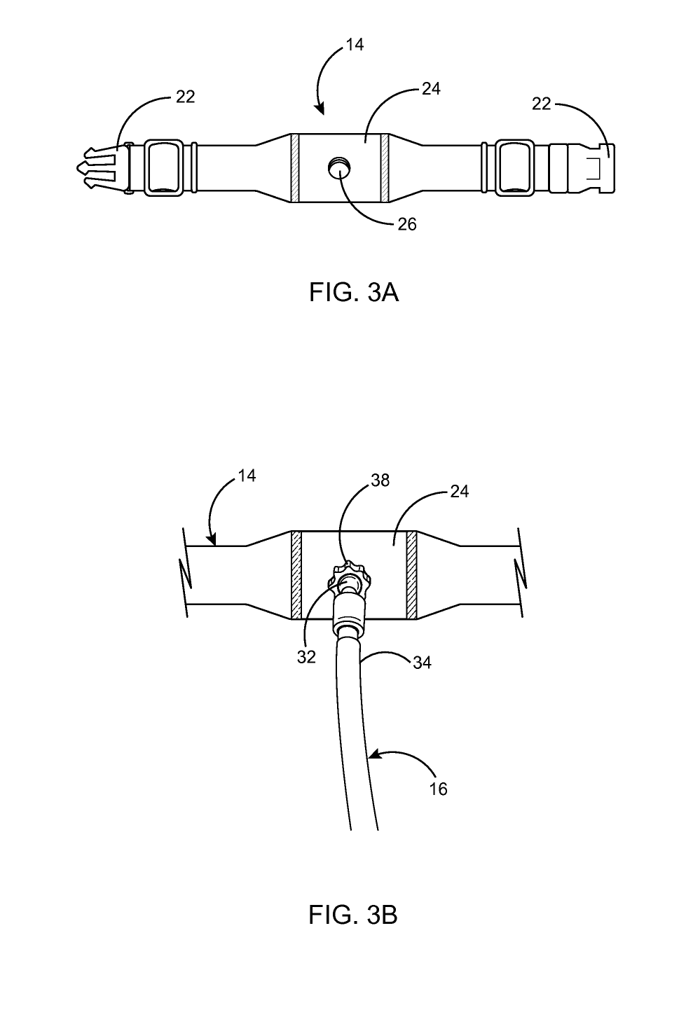

FIG. 3 is an enlarged front perspective view of the belt 14 of the hands-free electronic device holder 10 in accordance with the preferred embodiment of the present invention. The belt 14 may be a nylon padded belt. Turning to FIG. 3A, a front view of the belt 14 is illustrated. The belt 14 is fastened by using the fastening means 22 which may be a belt buckle. The belt 14 has a mold 24 at a centre position. The mold 24 may be a hard plastic mold of approximately 4″×4″ size. The mold 24 has a threaded stud 26 in the middle for attachment of the flexible gooseneck 16 to the belt 14. The threaded stud 26 has a round hole 28 in the centre and a plurality of threads 30 along its outer surface. The round hole 28 receives a ball insert 32 of the flexible gooseneck 16 for attachment therewith as illustrated in FIG. 3B. The threaded stud 26 is slightly tapered up at an angle to give more support to the flexible gooseneck 16. The belt 14 secures the hands-free electronic device holder 10 to a user 20 (See FIG. 8) and provides support to the flexible gooseneck 16.

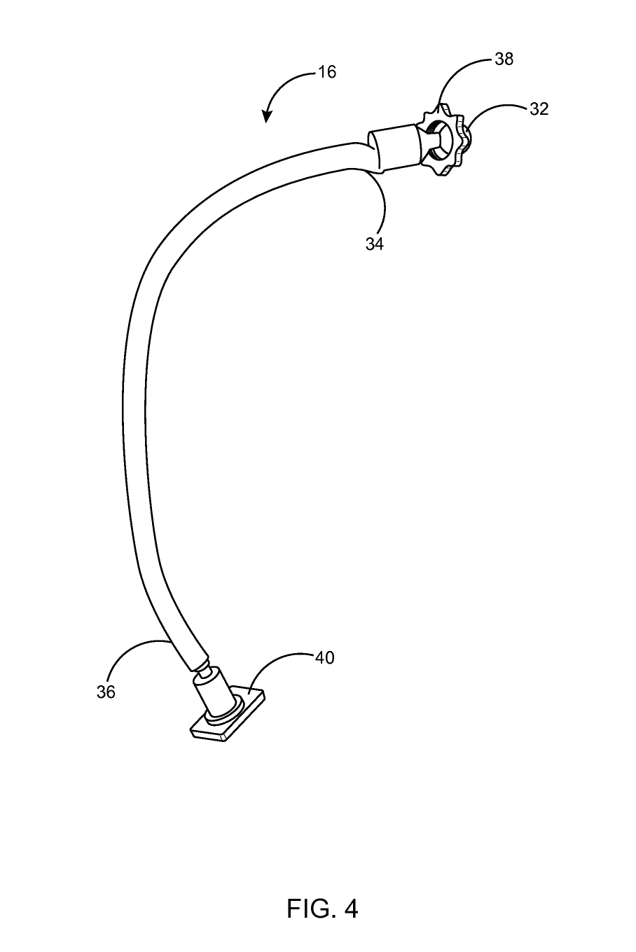

Turning to FIG. 4, a perspective view of the flexible gooseneck 16 of the hands-free electronic device holder 10 in accordance with the preferred embodiment of the present invention. The flexible gooseneck 16 has a proximal end 34 and a distal end 36. The proximal end 34 has a ball insert 32 and a threaded cap 38 over the ball insert 32 for attachment with the belt 14. The distal end 36 has a rotatable attachment means 40 for attachment with the holding assembly 18. The flexible gooseneck 16 may be adjusted to any orientation to suit a user 20 (See FIG. 8).

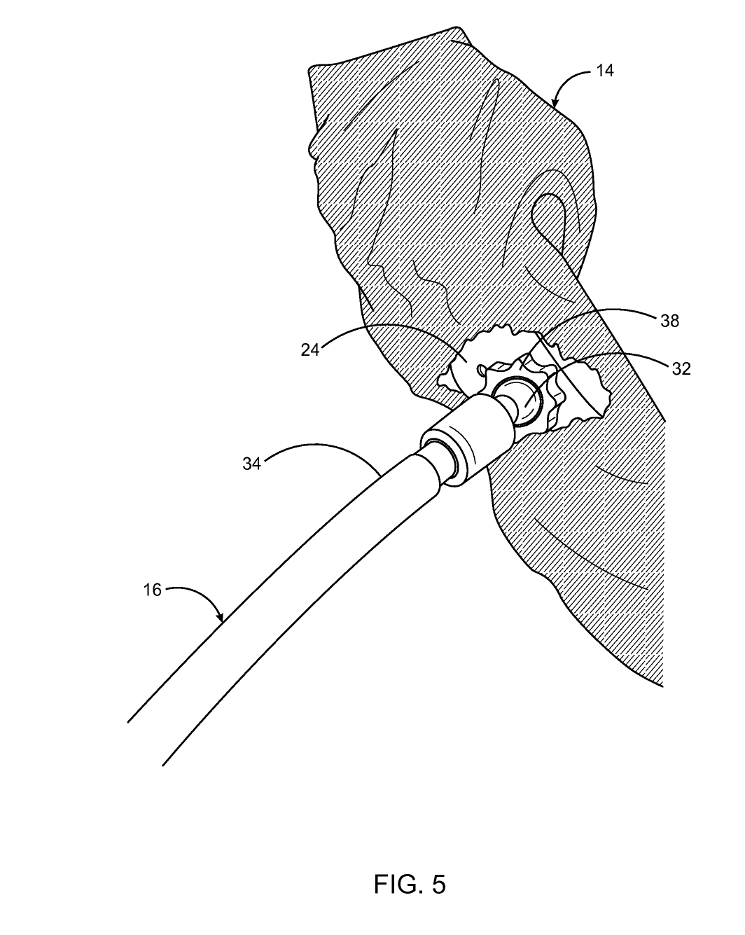

FIG. 5 illustrates an enlarged perspective view of the belt 14 and the flexible gooseneck 16 connected together, in accordance with the preferred embodiment of the present invention. The proximal end 34 of the flexible gooseneck 16 is attached to the belt 14 by inserting the ball insert 32 into the round hole 28 of the threaded stud 26. The threaded cap 38 is then winded onto the threaded stud 26 over the ball insert 32 which locks the ball insert 32 in place after it is snapped in.

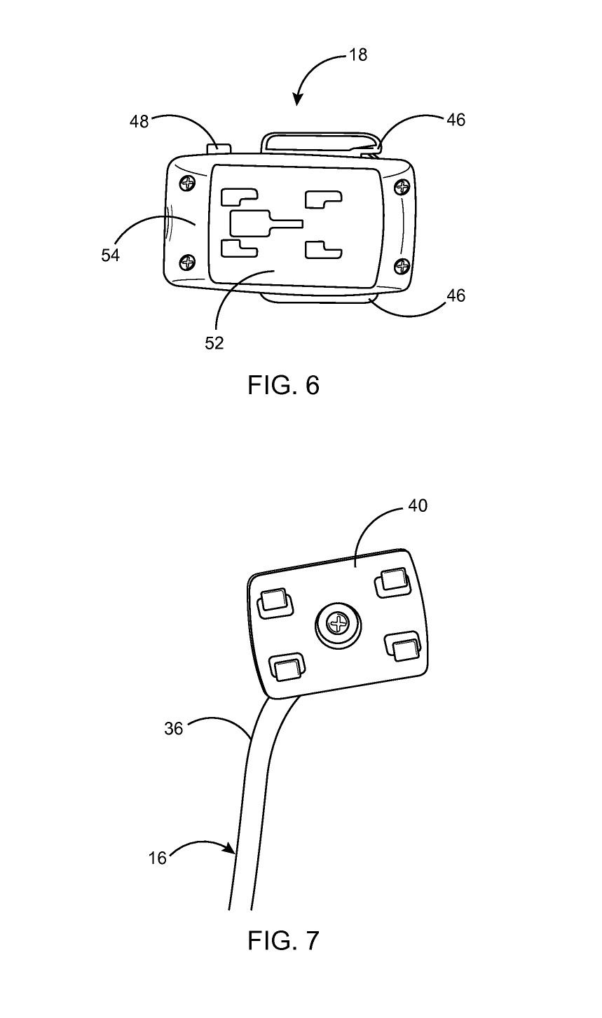

FIG. 6 is a rear perspective view of the holding assembly 18 of the hands-free electronic device holder 10 in accordance with the preferred embodiment of the present invention. Referring to FIGS. 1 and 6, the holding assembly 18 has a padded area 42 at a front portion 44 for cushioning the electronic device 12 held therein. A pair of padded clamps 46 for adjustably holding the electronic device 12 is present on the sides. The pair of padded clamps 46 open and close to fit different sizes of electronic devices 12. A button 48 is present for automatically adjusting a distance between the pair of padded clamps 46 at a side portion 50. The holding assembly 18 also has a fixed attachment means 52 at a back portion 54 for attachment with the distal end 36 of the flexible gooseneck 16. The holding assembly 18 uses a gear mechanism to adjust the distance between the pair of padded clamps 46.

FIG. 7 illustrates an enlarged perspective view of the rotatable attachment means 40 of the flexible gooseneck 16 in accordance with the preferred embodiment of the present invention. The distal end 36 of the flexible gooseneck 16 is attached to the holding assembly 18 by connecting the rotatable attachment means 40 to the fixed attachment means 52 at the back portion 54 of the holding assembly 18. After attaching the holding assembly 18 to the flexible gooseneck 16, the rotatable attachment means 40 may be rotated in 360 degrees to change the orientation of a screen of the electronic device 12 held in the holding assembly 18.

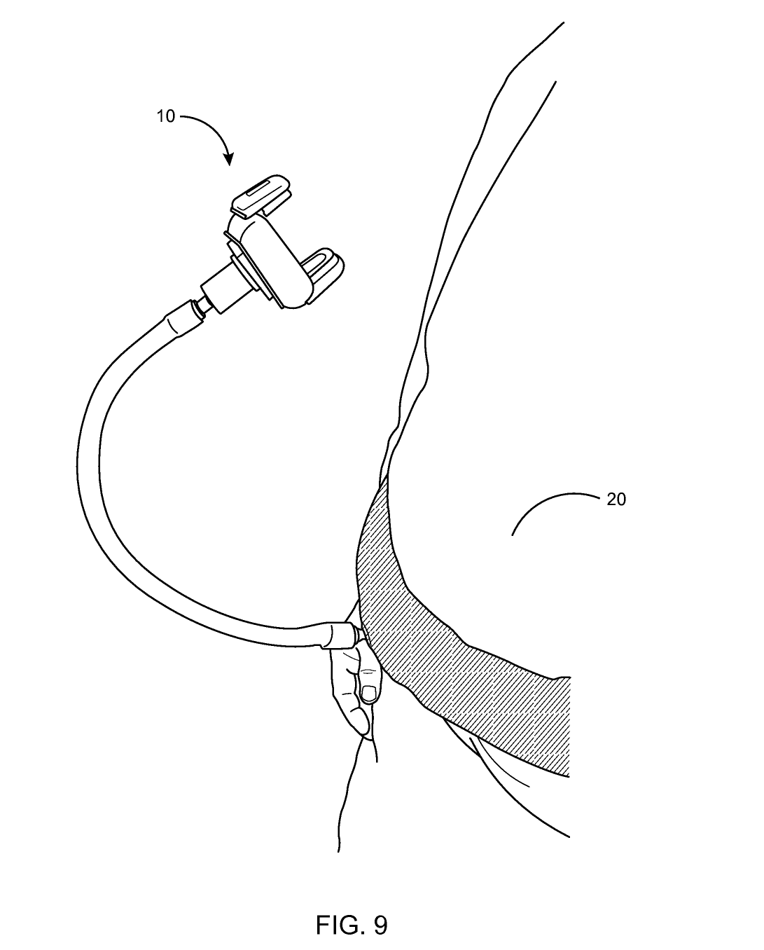

FIGS. 8-9 illustrate the hands-free electronic device holder 10 worn by a user 20. The hands-free electronic device holder 10 is secured around the waist of the user 20 by the belt 14. The hands-free electronic device holder 10 maintains the electronic device 12 in front of the face of the user 20 or any desired orientation at the right distance and angle for convenient viewing while moving, sitting, standing, or reclining position. The hands-free electronic device holder 10 is capable of supporting various electronic devices such as smart phones, tablets, video MP3 players, mobile telephones and personal digital assistants (PDAs).

While a particular form of the invention has been illustrated and described, it will be apparent that various modifications can be made without departing from the spirit and scope of the invention. Accordingly, it is not intended that the invention be limited, except as by the appended claims.

What is claimed is:

1. A hands-free electronic device holder comprising:
a belt being wrapped around a waist of a user, the belt having a mold at a centre position, the mold having a threaded stud therein;
a flexible gooseneck having a proximal end and a distal end, the proximal end having a ball insert for attachment with the belt and the distal end having a rotatable attachment means; and
a holding assembly having a pair of padded clamps for adjustably holding an electronic device, the holding assembly being attached to the distal end of the flexible gooseneck;
whereby the flexible gooseneck being configured to he adjusted to any orientation to align the position of the electronic device to be at face level of the user, providing hands-free operation of the electronic device while sitting down, standing, moving, and reclining.

2. The hands-free electronic device holder of claim 1 wherein the belt is secured around the waist of the user by a fastening means.

3. The hands-free electronic device holder of claim 1 wherein the flexible gooseneck has a threaded cap at the proximal end over the ball insert for securing the ball insert to the threaded stud.

4. The hands-free electronic device holder of claim 3 wherein the proximal end of the flexible gooseneck is attached to the belt by inserting the ball insert into the threaded stud and winding the threaded cap onto the threaded stud over the ball insert.

5. The hands-free electronic device holder of claim 1 wherein the distal end of the flexible gooseneck is attached to the holding assembly by connecting the rotatable attachment means to a fixed attachment means at a back portion of the holding assembly.

6. The hands-free electronic device holder of claim I wherein the rotatable attachment means is rotated in 360 degrees to change the orientation of the electronic device held in the holding assembly.

7. The hands-free electronic device holder of claim 1 wherein the holding assembly has a padded area at a front portion to cushion the electronic device held therein.

8. The hands-free electronic device holder of claim 1 wherein the holding assembly has a button for automatically adjusting a distance between the pair of padded clamps to accommodate different sizes of the electronic device.

9. The hands-free electronic device holder of claim 8 wherein the holding assembly uses a gear mechanism to adjust the distance between the pair of padded clamps.

10. An electronic device holder worn by a user for hands-free operation of the electronic device, the electronic device holder comprising:
a belt being wrapped around a waist of the user via a fastening means, the belt having a mold at a center position, the mold having a threaded stud therein;
a flexible gooseneck having a proximal end and a distal end, the proximal end having a ball insert and a threaded cap over the ball insert for attachment with the belt and the distal end having a rotatable attachment means; and
a holding assembly having a padded area at a front portion for cushioning the electronic device held therein, a pair of padded clamps for adjustably holding the electronic device and a button for automatically adjusting a distance between the pair of padded clamps at a side portion, and a fixed attachment means at a back portion for attachment with the distal end of the flexible gooseneck;
whereby the flexible gooseneck being configured to be adjusted to any orientation to align the position of the electronic device to be at face level of the user, providing hands-free operation of the electronic device while sitting down, standing, moving, and reclining.

11. The hands-free electronic device holder of claim 10 wherein the proximal end of the flexible gooseneck is attached to the belt by inserting the ball insert into the threaded stud and winding the threaded cap onto the threaded stud over the ball insert.

12. The hands-free electronic device holder of claim 10 wherein the distal end of the flexible gooseneck is attached to the holding assembly by connecting the rotatable attachment means to the fixed attachment means at the back portion of the holding assembly.

13. The hands-free electronic device holder of claim 10 wherein the rotatable attachment means is rotated in 360 degrees to change the orientation of a screen of the electronic device held in the holding assembly.

14. The hands-free electronic device holder of claim 10 wherein the holding assembly uses a gear mechanism to adjust the distance between the pair of padded clamps.

15. The hands-free electronic device holder of claim 10 supports the electronic device at different angles and orientations while accommodating different sizes.

16. A method for supporting an electronic device for hands-free operation, the method comprising the steps of:
a) providing a hands-free electronic device holder to a user, the hands-free electronic device comprising a belt, a flexible gooseneck and a holding assembly;
b) securing the belt around a waist of the user by a fastening leans, the belt having a mold at a center position, the mold having a threaded stud therein;
c) connecting a proximal end of the flexible gooseneck to the belt by inserting a ball insert at the proximal end of the flexible gooseneck into the threaded stud;
d) winding a threaded cap at the proximal end of the flexible gooseneck onto the threaded stud over the ball insert;
e) connecting a distal end of the flexible gooseneck to the holding assembly by connecting a rotatable attachment means at the distal end of the flexible gooseneck to a fixed attachment means at a back portion of the holding assembly;
f) placing the electronic device into the holding assembly and adjusting a distance between a pair of padded clamps at a side portion of the holding assembly to tightly clamp the electronic device in place;
g) adjusting the orientation of the flexible gooseneck to align the position of the electronic device to be at face level of the user; and
h) rotating the holding assembly to change the orientation of a screen of the electronic device to be comfortable to the user.

17. The method of claim 16 wherein the flexible gooseneck may be adjusted to any orientation to suit the user.

18. The method of claim 16 wherein the rotatable attachment means may be rotated in 360 degrees to change the orientation of the screen of the electronic device held in the holding assembly.

19. The method of claim 16 wherein the holding assembly has a button for automatically adjusting the distance between the pair of padded clamps to accommodate different sizes of the electronic device.

20. The method of claim 16 wherein the holding assembly uses a gear mechanism to adjust the distance between the pair of padded clamps.
